(19) United States
(12) Patent Application Publication
(10) Pub. No.: US 2026/0245572 A1
(43) Pub. Date: Aug. 20, 2026

(54) ELECTRONIC DEVICE FOR PROCESSING AUDIO DATA AND CONTROL METHOD THEREOF

(71) Applicants: SAMSUNG ELECTRONICS CO., LTD., Suwon-si (KR); IUCF-HYU (INDUSTRY-UNIVERSITY COOPERATION FOUNDATION HANYANG UNIVERSITY), Seoul (KR)

(72) Inventors: Hangil MOON, Suwon-si (KR); Joonhyuk CHANG, Seoul (KR); Geeyeun KIM, Suwon-si (KR); Jaemo YANG, Suwon-si (KR); Jeonghwan CHOI, Suwon-si (KR); Brian HAN, Suwon-si (KR); Dail KIM, Seoul (KR); Yungyeo KIM, Seoul (KR); Kyoungho BANG, Suwon-si (KR); Minsang BAEK, Seoul (KR); Wongook CHOI, Seoul (KR)

(21) Appl. No.: 19/644,573

(22) Filed: Apr. 10, 2026

Related U.S. Application Data
(63) Continuation of application No. PCT/KR2024/015141, filed on Oct. 4, 2024.

(51) Int. Cl. G10L 21/0208; G10L 15/06

(52) U.S. Cl. CPC G10L 21/0208; G10L 15/063

(57) ABSTRACT

An electronic device includes at least one processor and memory storing instructions that cause the electronic device to: input a Gaussian noise and first audio data recorded by a first audio device as input data of an artificial intelligence model; and on the basis of the first audio data and output data of the artificial intelligence model, obtain second audio data into which the first audio data has been transformed to include a feature of an audio sound recorded by a second audio device, and the artificial intelligence model may be trained to, on the basis of a diffusion model, use a Gaussian noise and audio data recorded by the second audio device to generate diffusion data in which a noise is included in the audio data, and extract the noise included in the diffusion data through a reverse process of the diffusion model.

### CROSS-REFERENCE TO RELATED APPLICATIONS

This application is a continuation application under, 35 U.S.C. § 111 (a), of International Patent Application No. PCT/KR2024/015141, filed on Oct. 4, 2024, which claims priority to Korean Patent Application No. 10-2023-0135466, filed on Oct. 11, 2023, and Korean Patent Application No. 10-2023-0175942, filed on Dec. 6, 2023, the content of which in their entirety is herein incorporated by reference.

### BACKGROUND

### 1. Field

Embodiments of the disclosure relate to an electronic device for processing audio data and a method for controlling the same.

### 2. Description of Related Art

Various services and additional functions provided through electronic devices, for example, portable electronic devices such as smartphones, are gradually increasing. In order to increase the utility value of these electronic devices and satisfy the desires of various users, communication service providers or electronic device manufacturers are competitively developing electronic devices to provide various functions and differentiate themselves from other companies. Accordingly, various functions provided through electronic devices are also becoming increasingly sophisticated.

The performance of artificial neural network-based acoustic processing technologies (e.g., acoustic scene classification, sound source detection technology, and so on) may be affected by the acoustic hardware of a device that records sound. For example, when an electronic device that collects audio data used for training is different from an electronic device to which actual audio data is to be applied, acoustic processing performance may be limited due to distortion caused by differences in device characteristics.

The above information is presented as related art to assist with an understanding of the disclosure. No determination has been made, and no assertion is made, as to whether any of the above might be applicable as prior art with regard to the disclosure.

### SUMMARY

According to an embodiment, an electronic device includes at least one processor including processing circuitry and memory storing instructions that, when executed by the at least one processor, individually or collectively, cause the electronic device to perform operations.

According to an embodiment, the operations include inputting first audio data recorded through a first audio device and Gaussian noise as input data of an artificial intelligence model stored in the memory.

According to an embodiment, the operations include based on the first audio data and output data of the artificial intelligence model, obtaining second audio data in which the first audio data is converted to include a feature of audio recorded in a second audio device.

According to an embodiment, the artificial intelligence model is trained to, based on a diffusion model, generate diffusion data including noise in audio data based on audio data recorded in the second audio device and Gaussian noise, and extract the noise included in the diffusion data through an inverse process of the diffusion model.

According to an embodiment, a method for controlling an electronic device includes inputting first audio data recorded through a first audio device and Gaussian noise as input data of an artificial intelligence model stored in memory.

According to an embodiment, the method for controlling the electronic device includes, based on the first audio data and output data of the artificial intelligence model, obtaining second audio data in which the first audio data is converted to include a feature of audio recorded in a second audio device.

According to an embodiment, the artificial intelligence model is trained to, based on a diffusion model, generate diffusion data including noise in audio data based on audio data recorded in the second audio device and Gaussian noise, and extract the noise included in the diffusion data through an inverse process of the diffusion model.

According to an embodiment, in a non-transitory computer-readable recording medium storing instructions configured to be executed by at least one processor of an electronic device to perform operations that include inputting first audio data recorded through a first audio device and Gaussian noise as input data of an artificial intelligence model stored in memory of the electronic device.

According to an embodiment, the instructions when executed by the at least one processor, individually or collectively, cause the electronic device to, based on the first audio data and output data of the artificial intelligence model, obtain second audio data in which the first audio data is converted to include a feature of audio recorded in a second audio device.

According to an embodiment, the artificial intelligence model is trained to, based on a diffusion model, generate diffusion data including noise in audio data based on audio data recorded in the second audio device and Gaussian noise, and extract the noise included in the diffusion data through an inverse process of the diffusion model.

### BRIEF DESCRIPTION OF DRAWINGS

FIG. 1 is a block diagram illustrating an electronic device in a network environment according to an embodiment.

FIG. 2A is a diagram illustrating a simplified configuration of an electronic device according to an embodiment of the disclosure.

FIG. 2B is a diagram illustrating an artificial intelligence model for processing audio data according to an embodiment of the disclosure.

FIG. 3 is a flowchart illustrating an audio data processing operation of an electronic device according to an embodiment of the disclosure.

FIG. 4 is a flowchart illustrating an operation of training an artificial intelligence model for predicting noise included in audio data according to an embodiment of the disclosure.

FIG. 5 is a diagram illustrating an operation of training an artificial intelligence model for predicting noise included in audio data according to an embodiment of the disclosure.

FIG. 6 is a diagram illustrating an audio data processing operation based on noise predicted through an artificial intelligence model according to an embodiment of the disclosure.

FIG. 7 is a diagram illustrating an audio data processing operation based on noise predicted through an artificial intelligence model in an electronic device according to an embodiment of the disclosure.

FIG. 8 is a flowchart illustrating an audio data processing operation based on a trained artificial intelligence model in an electronic device according to an embodiment of the disclosure.

### DETAILED DESCRIPTION

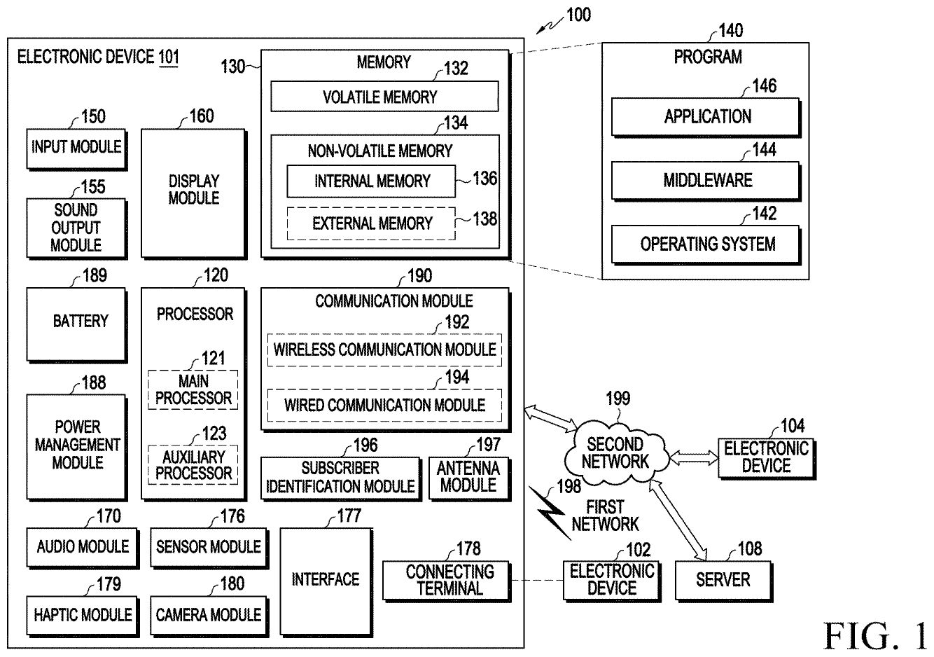

FIG. 1 is a block diagram illustrating an electronic device 101 in a network environment 100 according to embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

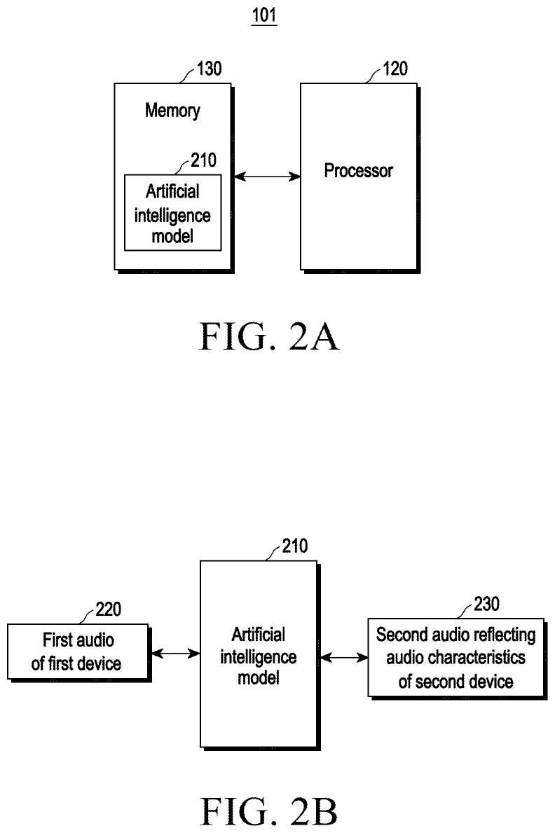

FIG. 2A is a diagram illustrating a simplified configuration of an electronic device according to an embodiment of the disclosure.

FIG. 2B is a diagram illustrating an artificial intelligence model for processing audio data according to an embodiment of the disclosure.

Referring to FIG. 2A, the electronic device 101 (e.g., the electronic device 101 of FIG. 1 or the processor 120 of FIG. 1) may include the memory 130 (e.g., the memory 130 of FIG. 1) and the processor 120 (e.g., the processor 120 of FIG. 1).

According to an embodiment, the memory 130 may store an artificial intelligence model 210.

According to an embodiment, as illustrated in FIG. 2B, the artificial intelligence model 210 may be trained to take first audio 220 (or audio data or audio signal) of a first device (or a first audio device or a standard audio device) as input data and output second audio 230 (or audio data or audio signal) in which audio characteristics of a second device (or a second audio device or a target audio device) are reflected. According to an embodiment, the first device and the second device may be devices having different audio characteristics.

According to an embodiment, although the second audio 230 has the same content as the first audio 220, the second audio 230 may reflect the audio characteristics of audio recorded by the second device. For example, the audio characteristics caused by the device may include distortion caused by the device that recorded the audio. The distortion caused by the device may be distortion caused by the acoustic hardware of the device. The distortion caused by the device may include linear distortion in a frequency response of the device and non-linear distortion such as, for example, filtering and a dynamic range.

According to an embodiment, the artificial intelligence model 210 may be trained to generate diffusion data in which noise is included in audio data based on audio data recorded by the second device and Gaussian noise, using a diffusion model, and extract the noise included in the diffusion data through a reverse process of the diffusion model. According to an embodiment, the diffusion data is not limited to being generated based on Gaussian noise and may be generated by noise that follows various distributions, such as, for example, a Gamma distribution. While the following description will be given with the appreciation that diffusion data is generated using Gaussian noise by way of example, for convenience of description, the disclosure is not limited thereto.

According to an embodiment, the diffusion model is designed based on Langevin dynamics, which represents the scattering of molecules in an initial state over time.

According to an embodiment, the diffusion model may be divided into a forward transformation and a reverse transformation. The forward transformation (or diffusion process) is to transform data into noise, and the reverse transformation (or denoising process) is to obtain data from noise.

According to an embodiment, the artificial intelligence model 210 may be trained using audio data recorded through the second device and Gaussian noise. For example, the artificial intelligence model 210 may be trained to generate diffusion data based on audio data recorded through the second device and Gaussian noise, receive the diffusion data, and output noise estimated to have been used in the diffusion data. According to an embodiment, the artificial intelligence model 210 may be further trained using audio data recorded through the first device as input data.

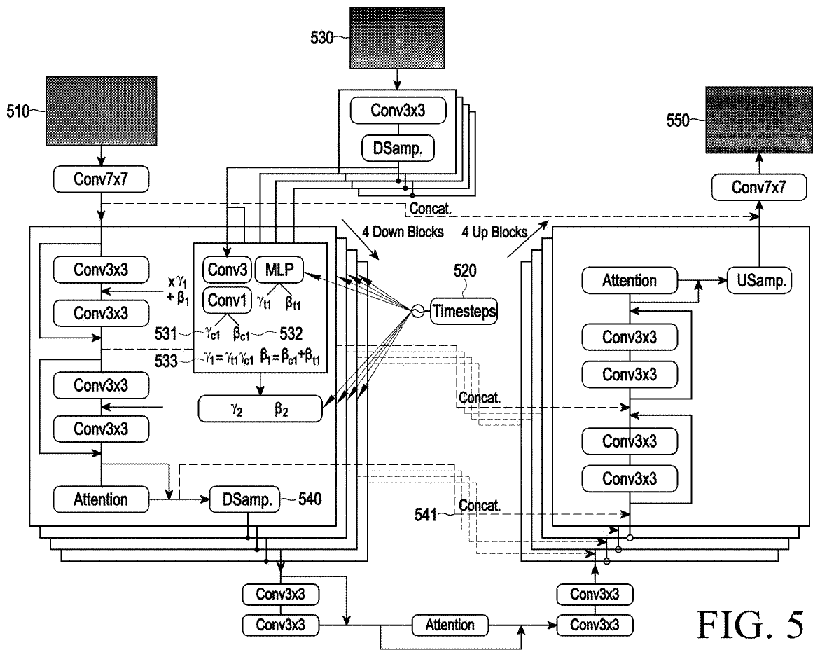

According to an embodiment, the artificial intelligence model 210 may have a U-Net structure, such as a CNN architecture with contraction, expansion, and skip connections to retain higher resolution content that may otherwise be lost during down-sampling. The U-Net structure may output a highly accurate result by repeating a predetermined algorithm several times and transmit the output result data to the next step. According to an embodiment, the artificial intelligence model 210 having the U-Net structure will be described below in more detail with reference to FIG. 5.

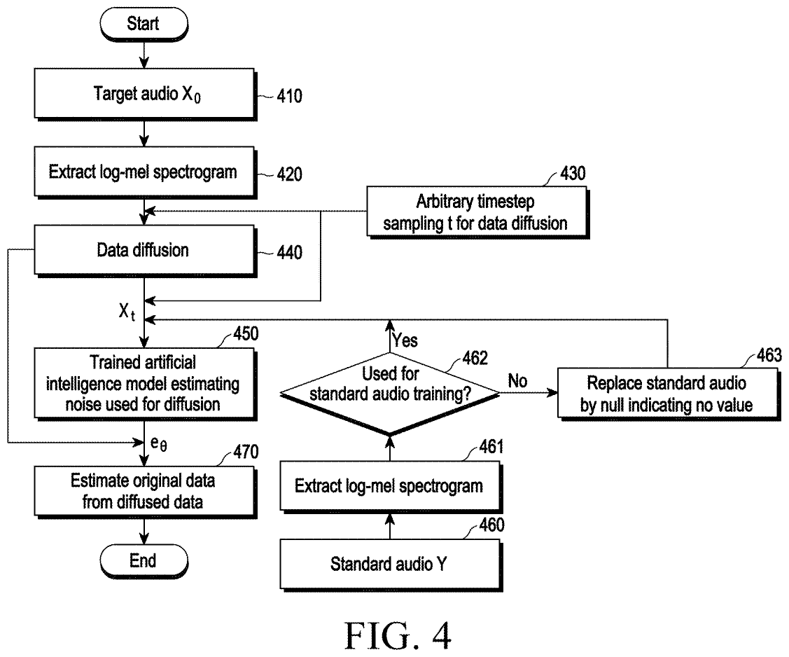

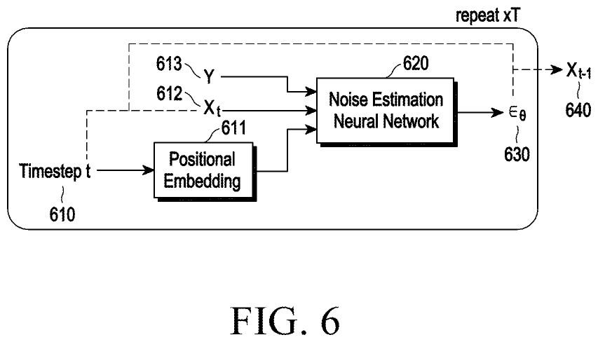

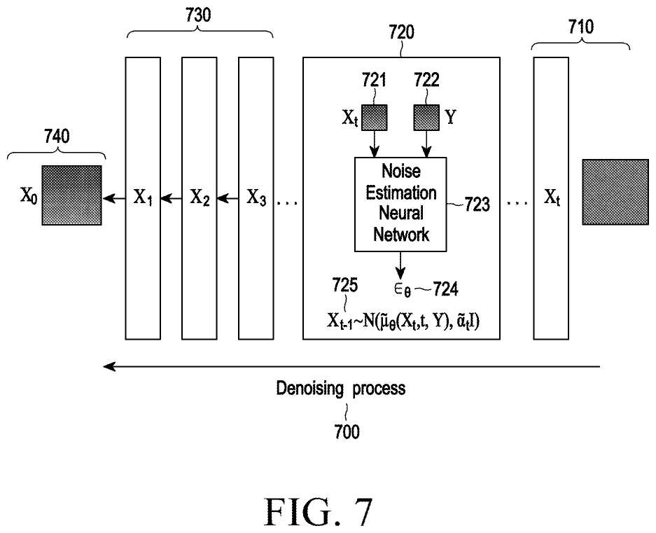

According to an embodiment, the operation of training the artificial intelligence model 210 will be described below in more detail with reference to FIG. 4, FIG. 5, FIG. 6, and FIG. 7.

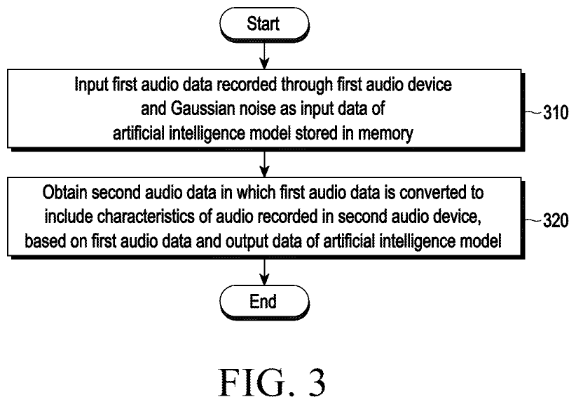

FIG. 3 is a flowchart illustrating an audio data processing operation of an electronic device according to an embodiment of the disclosure.

Referring to FIG. 3, in operation 310, the electronic device (e.g., the electronic device 101 of FIG. 1, the processor 120 of FIG. 1, or the electronic device 101 of FIG. 2) may input first audio data recorded through a first audio device and Gaussian noise as input data for an artificial intelligence model stored in memory.

According to an embodiment, the artificial intelligence model (e.g., the artificial intelligence model 210 of FIG. 2B) may be trained to generate diffusion data in which noise is included in audio data based on a diffusion model using audio data recorded by a second audio device and Gaussian noise, and extract the noise included in the diffusion data through a reverse process of the diffusion model.

According to an embodiment, the artificial intelligence model may generate the diffusion data by combining the audio data and the Gaussian noise at a set ratio.

According to an embodiment, the artificial intelligence model may change the set ratio and generate second diffusion data based on the changed ratio. According to an embodiment, the artificial intelligence model may perform training by repeating an operation of extracting second noise based on the second diffusion data a set number of times. For example, the artificial intelligence model may generate the diffusion data such that the ratio of the Gaussian noise out of the audio data and the Gaussian noise gradually increases (or gradually decreases). According to an embodiment, the artificial intelligence model may perform training to extract noise from each of the generated diffusion data.

According to an embodiment, the artificial intelligence model may further use audio data recorded by the first audio device as input data.

According to an embodiment, the artificial intelligence model may include a first artificial intelligence model trained by further using audio data recorded by the first audio device as input data. According to an embodiment, the artificial intelligence model may include not only the first artificial intelligence model but also a second artificial intelligence model trained without using audio data recorded by the first audio device as input data.

According to an embodiment, the electronic device may obtain output data by combining first output data of the first artificial intelligence model and second output data of the second artificial intelligence model. According to an embodiment, the electronic device may obtain the first output data through the first artificial intelligence model with a probability of about 50% and obtain the second output data through the second artificial intelligence model with a probability of about 50%. Here, about 50% can include a range of values, such as 48%-52%, 45%-55%, and other ranges depending upon a target accuracy.

For example, the electronic device may obtain the output data by combining the first output data (e.g., first noise) obtained through the first artificial intelligence model and the second output data (e.g., second noise) obtained through the second artificial intelligence model using extrapolation. Extrapolation is a method of estimating a value in a range outside a specific range based on known values within the specific range. According to an embodiment, the electronic device may estimate the output data based on the first output data and the second output data.

Accordingly, a pattern of non-linear distortion as well as linear distortion in a frequency response of the second device may be obtained, and an audio signal recorded by the first device may be converted to have the characteristics of audio recorded by the second device by reflecting distortion characteristics in the audio signal.

According to an embodiment, in operation 320, the electronic device may obtain second audio data converted, which can result in the first audio data including the characteristics of the audio recorded by the second audio device, based on the first audio data and the output data of the artificial intelligence model.

According to an embodiment, the electronic device may obtain the second audio data by removing noise, which is the output data of the artificial intelligence model, from the first audio data.

According to an embodiment, the electronic device may obtain the second audio data by repeating the operation of removing noise, which is the output data of the artificial intelligence model, from the first audio data a set number of times.

According to an embodiment, the second audio data may be used as training data for an artificial intelligence model for at least one of sound, voice recognition, or speaker recognition of the second audio device. For example, the second audio data in which the audio characteristics of the second audio device (or target audio device) are reflected may be used as training data optimized for the second audio device in a process of building an artificial neural network-based acoustic scene classification or sound source detection model.

According to an embodiment, when the acquisition of audio data using the target audio device is limited, the electronic device of the disclosure may obtain audio data having a style recorded by the target audio device using audio data collected through the standard audio device.

According to an embodiment, the electronic device of the disclosure may convert the styles of an unspecified number of speakers into the style of a specific speaker by applying the target audio device in the style of the specific speaker and the standard audio device in the styles of the unspecified number of speakers.

According to an embodiment, the electronic device of the disclosure may obtain sound that is actually listenable by learning an operation of restoring a log-mel spectrogram into an audible sound signal.

According to an embodiment, the electronic device of the disclosure may provide an experience where users from different environments feel as if they are in the same space by converting audio generated in different environments in a virtual reality environment to reflect the characteristics of audio in a specific environment.

FIG. 4 is a flowchart illustrating an operation of training an artificial intelligence model for predicting noise included in audio data according to an embodiment of the disclosure.

FIG. 5 is a diagram illustrating an operation of training an artificial intelligence model for predicting noise included in audio data according to an embodiment of the disclosure.

Referring to FIG. 4, in operation 410, an electronic device (e.g., the electronic device 101 of FIG. 1, the processor 120 of FIG. 1, or the electronic device 101 of FIG. 2A) may obtain target audio data X₀.

According to an embodiment, the target audio data may be obtained through public data. For example, data (e.g., TAU urban acoustic 2019 mobile dataset (e.g., TAU 2019 mobile)) recorded and provided in the same time and space using three different recording devices among public data may be used.

According to an embodiment, in operation 420, the electronic device may extract a log-mel spectrogram (e.g., a time-frequence spectrogram using a Mel scale to approximate human hearing) of the target audio. According to an embodiment, the electronic device may extract the log-mel spectrogram after down-sampling the target audio.

According to an embodiment, the electronic device may obtain a target audio log-mel spectrogram 510 as input data, as illustrated in FIG. 5.

According to an embodiment, in operation 430, the electronic device may obtain an arbitrary timestep sampling t 520 for data diffusion, as illustrated in FIG. 5. According to an embodiment, Gaussian noise may be defined by a timestep T, and t may be sampled as an integer from 0 to T.

According to an embodiment, the electronic device may perform generation by skipping some steps instead of performing timestep sampling for the entire parameter T. Accordingly, the electronic device may increase a generation speed by reducing the amount of computation required for generating the diffusion data and be capable of real-time expansion.

According to an embodiment, in operation 440, the electronic device may perform data diffusion based on the log-mel spectrogram and the timestep sampling t 520.

For example, the electronic device may output diffusion data Xₜ based on the log-mel spectrogram and the timestep sampling t using a diffusion model.

According to an embodiment, a latent diffusion feature map Xₜ may be defined through the following equation for audio X₀ recorded with a target audio device in a method defined in a diffusion probabilistic model.

$${X}_{t} = \sqrt{{α}_{1}} {X}_{t - 1} + \sqrt{1 - {α}_{i}} {e}_{t} , {e}_{t} \sim N ( 0 , I ) \qquad Equation ( 1 )$$

Herein, aₜ is a predefined data diffusion policy and may have a value of 1>a₀>a₁> . . . >a_{T}»0. at may follow the following equation.

$${α}_{t} = \frac{{α}_{T} - {α}_{0}}{T} t + {α}_{0} , {α}_{0} = 0.9999 , {α}_{T} = 0.98$$

According to an embodiment, when Xₜ is expressed as a probability distribution, Xₜ may be expressed as a probability variable following a Gaussian distribution of, Xₜ~q(Xₜ|Xₜ₋₁)=N(\sqrt{aₜ}Xₜ₋₁, \sqrt{1−aₜ}1), and assuming that Xₜ follows a Markov chain (e.g., a distribution in a specific step depends on a sample in the immediately previous step), Xₜ may be expressed as Equation (2) below. This may be equivalent to Equation (1).

$${X}_{t} = \sqrt{{\overline{α}}_{t}} {X}_{0} + \sqrt{1 - {\overline{α}}_{t}} {e}_{t} , {e}_{t} \sim N ( 0 , I ) , {\overline{α}}_{t} = {\prod }_{t = 0}^{t} {α}_{t} \qquad Equation ( 2 )$$

According to an embodiment, when the posterior data X₀ (or observed noise eₜ used for diffusion) and the diffused data Xₜ are known, Xₜ₋₁ may be predicted by defining a reverse process q(Xₜ₋₁|Xₜ, X₀) of the diffusion model according to Equation (3) below using Equations (1) and (2) and Bayes' rule.

$${X}_{t - 1} \sim q ( {X}_{t - 1} \vert {X}_{t} , {X}_{0} ) = \frac{q ( {X}_{t} \vert {X}_{t - 1} ) q ( {X}_{t - s} \vert {X}_{0} )}{q ( {X}_{t} \vert {X}_{0} )} = N ( {\tilde{μ}}_{t} , {\tilde{α}}_{t} I ) , {\tilde{μ}}_{t} = \frac{1}{\sqrt{{α}_{t}}} ( {X}_{t} - \frac{1 - {α}_{t}}{\sqrt{1 - {\overline{α}}_{t}}} {e}_{t} ) , {\tilde{α}}_{t} = \frac{1 - {\overline{α}}_{t}}{1 - {\overline{α}}_{t - 1}} ( 1 - {α}_{t} ) \qquad Equation ( 3 )$$

According to an embodiment, in operation 450, the electronic device may train the artificial intelligence model that estimates noise used for diffusion based on the diffusion data Xₜ. According to an embodiment, the electronic device may further use the timestep sampling as input data during the training of the artificial intelligence model.

According to an embodiment, the artificial intelligence model may have a U-Net structure as illustrated in FIG. 5. According to an embodiment, the entire structure except for linear distortion (feature-wise linear modulation (FILM)) may be identical to a U-Net structure used in denoising diffusion probabilistic model (DDPM)-based approaches. According to an embodiment, an input channel size and a channel multiplier for each layer may be set to 16 and (1, 2, 4, 8), respectively.

According to an embodiment, when training the artificial intelligence model, the electronic device may further use standard audio data Y as input data. For example, in operation 460, the electronic device may obtain the standard audio data Y.

According to an embodiment, in operation 461, the electronic device may extract a log-mel spectrogram of the standard audio data Y.

According to an embodiment, the electronic device may obtain a standard audio log-mel spectrogram 530 as input data as illustrated in FIG. 5.

According to an embodiment, in operation 462, the electronic device may determine whether to use the standard audio data for training.

According to an embodiment, the electronic device may determine whether to use the standard audio data for training with a probability of about 50%, for example. Other probabilities can be used depending on performance targets.

For example, the standard audio data Y 530 may be an input to a FILM layer, and the data Y input to the FiLM layer may pass through a 3×3 convolution layer that maintains the channel size and then a 1×1 convolution layer that doubles the channel size.

According to an embodiment, when the standard audio data is used for training (operation 462—Yes), the electronic device may use the log-mel spectrogram of the standard audio data as input data during artificial intelligence training.

According to an embodiment, when the standard audio data is not used for training (operation 462—No), the electronic device may replace the standard audio data with null indicating no value in operation 463. According to an embodiment, the electronic device may not use the standard audio data as input data during artificial intelligence model training by setting the standard audio data to null.

For example, half of the doubled number of channels may be γ_{c1} 531, and the other half may be β_{c1} 532, as illustrated in FIG. 5.

According to an embodiment, for the timestep t 520, after a time embedding is extracted and passes through a linear layer that doubles the dimension within the channel FiLM layer, Yu and βₜ₁ are extracted in the same manner and the dimensions may be the same as γ_{c1} and β_{c1}, respectively. Finally, a FiLM scale γ₁=γ_{c1}γₜ₁, a deviation β₁=β_{c1}βₜ₁, and γ₂ and β₂ may be calculated in the same manner.

According to an embodiment, the electronic device may train the artificial intelligence model to output noise e_{g} 540 as output data, as illustrated in FIG. 5.

According to an embodiment, the electronic device may include an artificial intelligence model (e.g., a noise estimation neural network) that takes Xₜ, t, and Y as an input and outputs e_{g} 540, targeting noise eₜ diffused during diffusion from X₀ to Xₜ. According to an embodiment, the structure of the artificial intelligence model may be a U-Net structure as illustrated in FIG. 5. According to an embodiment, the electronic device may use a mean squared error ∥eₜ−e_{g}∥² as an objective function to optimize p_{g}(Xₜ₋₁|Xₜ, t, Y). For example, optimization may be performed such that ∥eₜ−e_{g}∥² is minimized for randomly extracted during each training.

According to an embodiment, to more effectively reflect a non-linear distortion component using the artificial intelligence model, the electronic device may use an optimization method that substitutes Y=(null), meaning ‘no input,’ for the target audio data Y used as an input with a probability of 50%. According to an embodiment, when Y=(null), γ_{c1}=1 and β_{c1}=0, as illustrated in FIG. 5. In this manner, when the data of the target audio data Y is null, the non-linear distortion component may be better predicted.

According to an embodiment, in operation 470, the electronic device may estimate original data from the diffused data, as illustrated in FIG. 6. According to an embodiment, the original data may be estimated by removing noise from the diffused data.

FIG. 6 is a diagram illustrating an audio data processing operation based on noise predicted through an artificial intelligence model according to an embodiment of the disclosure.

Referring to FIG. 6, the electronic device may perform positional embedding 611 based on a timestep t 610 of Gaussian noise.

According to an embodiment, the electronic device may input the positional embedding 611, diffusion data 612 obtained based on the Gaussian noise timestep t 610, and standard audio data Y 613 into an artificial intelligence model 620 (e.g., a noise estimation neural network).

According to an embodiment, the electronic device may obtain noise e_{g} 630 used in the diffusion data 612 as output data through the artificial intelligence model 620.

According to an embodiment, the electronic device may obtain original data Xₜ₋₁ 640 through a denoising process that removes the noise 630 from the diffusion data 612.

According to an embodiment, the electronic device may perform as many denoising processes as T steps defined in the diffusion process, as illustrated in FIG. 7.

FIG. 7 is a diagram illustrating an audio data processing operation based on noise predicted through an artificial intelligence model in an electronic device according to an embodiment of the disclosure.

Referring to FIG. 7, the electronic device may repeatedly denoise 720 initially input Gaussian noise 710 through a denoising process 700 as many times as T steps to finally output an audio signal 730 in which the characteristics of a target audio device are reflected. For example, the electronic device may obtain noise 724 used in diffusion data 721 and audio Y 722 of a standard audio device as output data through an artificial intelligence model 723 (e.g., a noise estimation neural network).

According to an embodiment, the electronic device may obtain original data X₀ 740 through (e.g., T) repetitions of the denoising step that removes the noise 724 from the diffusion data 721.

According to an embodiment, the initial Gaussian noise is removed through the artificial intelligence model 723 in every step, allowing for the acquisition of a latent diffusion feature map Xₜ₋₁ 725 corresponding to each denoising step. According to an embodiment, the latent diffusion feature map is an interior division point between an output signal defined in the diffusion process and the initial Gaussian noise, and the denoising process may be optimized by training with the latent diffusion feature map of each step defined in the diffusion process as a target.

According to an embodiment, the artificial intelligence model 723 may include a denoising process that estimates the probability distribution of the reverse process q(Xₜ₋₁|X₀) of the diffusion model using the audio signal Y recorded with the standard audio device, and a noise estimation model p_{g}(Xₜ₋₁|Xₜ, t, Y). According to an embodiment, the audio data X₀ recorded with the target audio device and the audio data Y recorded with the standard audio device may be recorded in the same time and space.

According to an embodiment, in order to convert the audio Y recorded with the standard audio device into the audio X₀ recorded with the target audio device using the optimized, p_{g}(Xₜ₋₁|Xₜ, t, Y), the reverse process of the diffusion model may be used as many times as T steps by using Xₜ₋₁~p_{g}(Xₜ₋₁|Xₜ, t, Y) instead of p_{g}(Xₜ₋₁|Xₜ, t, Y).

$${X}_{t - 1} = {\tilde{μ}}_{θ} + \sqrt{{\tilde{α}}_{t}} z , z \sim N ( 0 , I ) \qquad Equation ( 4 )$$

Since the target of e_{g} is eᵣ of Equation (3), \tilde{μ}_{g} may be replaced by an equation that uses e_{g} instead of eₜ in \tilde{μ}ₜ.

$${\tilde{μ}}_{0} = \frac{1}{\sqrt{{α}_{t}}} ( {X}_{t} - \frac{1 - {α}_{t}}{\sqrt{1 - {\overline{α}}_{t}}} {e}_{0} )$$

This may be represented as a simple algorithm as follows.

$$\begin{matrix}{X}_{T} \sim N ( 0 , I ) \\ {X}_{t} = {X}_{T}\end{matrix}$$

### for t in [T, . . . , 1] do

$$\begin{matrix}z \sim N ( 0 , I ) \\ {\tilde{μ}}_{0} = \frac{1}{\sqrt{{α}_{t}}} ( {X}_{t} - \frac{1 - {α}_{t}}{\sqrt{1 - {\overline{α}}_{t}}} {e}_{θ} ( {X}_{t} , t , Y ) ) \\ {X}_{t} = {\tilde{μ}}_{0} = \sqrt{{\tilde{α}}_{t}} z\end{matrix}$$

return Xₜ

According to an embodiment, the electronic device may change input audio data into the style of audio recorded by the target audio device in real-time through an expansion that skips some steps.

According to an embodiment, although the final output audio data has the same content as the input audio data, the final output audio data may be data in which characteristics and distortion components of the target audio device are reflected.

According to an embodiment, the audio data reflecting the characteristics of the target audio device may be used for training an artificial neural network for sound, voice recognition, and speaker recognition, or in a pre-process for an input of a target recording device system.

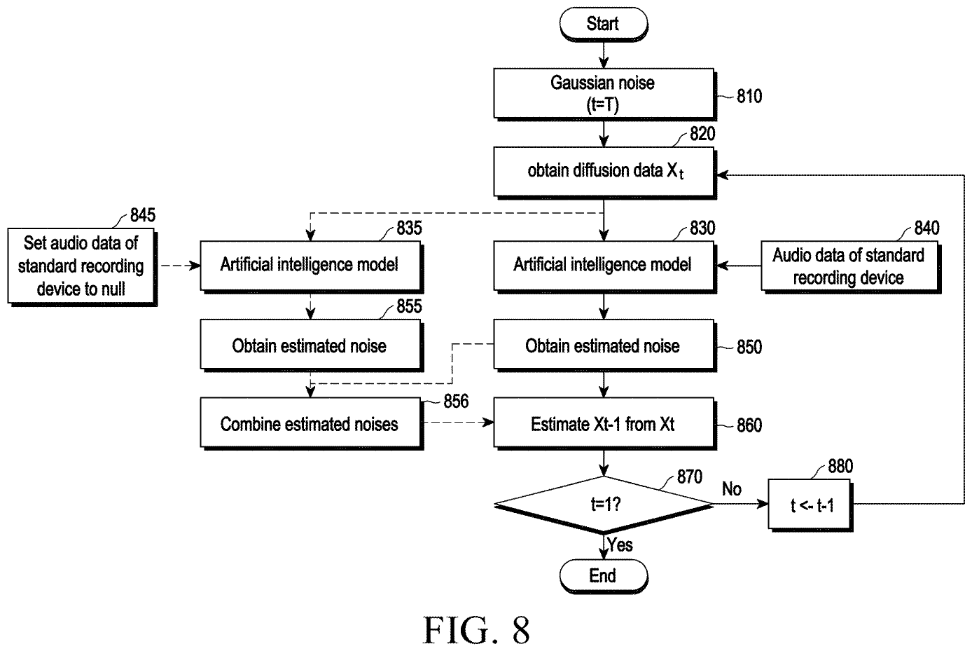

FIG. 8 is a flowchart illustrating an operation of processing audio data based on a trained artificial intelligence model in an electronic device according to an embodiment of the disclosure.

Referring to FIG. 8, in operation 810, the electronic device (e.g., the electronic device 101 of FIG. 1, the processor 120 of FIG. 1, or the electronic device 101 of FIG. 2A) may obtain Gaussian noise. According to an embodiment, the Gaussian noise may be arbitrary and extracted from a normal distribution.

According to an embodiment, in operation 820, the electronic device may obtain diffusion data Xₜ. According to an embodiment, the electronic device may obtain the diffusion data Xₜ based on the Gaussian noise using a diffusion model. For example, when an initial timestep t is defined as T, the electronic device may obtain X_{T} as diffusion data by sampling Gaussian noise at T.

According to an embodiment, the electronic device may input the diffusion data Xₜ obtained in operation 820 and audio data in operation 840 of a standard audio device as input data into an artificial intelligence model in operation 830 (e.g., a first artificial intelligence model).

According to an embodiment, in operation 850, the electronic device may obtain estimated noise as output data of the artificial intelligence model in operation 830. According to an embodiment, the electronic device may obtain noise estimated to be included in the diffusion data Xₜ through a reverse process of the diffusion model.

According to an embodiment, in operation 860, the electronic device may estimate Xₜ₋₁ from Xₜ. For example, the electronic device may obtain diffusion data Xₜ₋₁ by removing the estimated noise from Xₜ.

According to an embodiment, the electronic device may identify whether t=1 in operation 870.

According to an embodiment, when t is not 1 (operation 870—No), the electronic device may modify t to a value of t−1 in operation 880.

According to an embodiment, the electronic device may proceed to operation 820, set t to a value smaller than the previous t value by 1, and perform operations 830, 850, 860, and 870 again. According to an embodiment, the electronic device may repeatedly perform operations 830, 850, 860, and 870 while decreasing the value of t by 1 each time.

According to an embodiment, when t is 1 (operation 870—Yes), the electronic device may output the obtained Xₜ₋₁, which is X₀, as estimated original audio data.

According to an embodiment, the electronic device may further include an artificial intelligence model in operation 835 (e.g., a second artificial intelligence model) trained without using audio data of a standard audio device as input data.

According to an embodiment, in operation 845, the electronic device may set audio data of the standard audio device to (null). For example, the electronic device may substitute null, meaning ‘no input,’ into the audio data of the standard audio device.

According to an embodiment, the electronic device may input the diffusion data Xt obtained in operation 820 and the null value for the audio data of the standard audio device as input data into the artificial intelligence model in operation 835.

According to an embodiment, the electronic device may obtain estimated noise in operation 855.

According to an embodiment, in operation 856, the electronic device may combine the estimated noise obtained in operation 850 and the estimated noise obtained in operation 855. For example, the electronic device may combine the two estimated noises through extrapolation. Extrapolation is a method of estimating a value of a point located in an area outside an area limited by two points using the known values of those two points.

According to an embodiment, in operation 860, the electronic device may estimate Xₜ₋₁ from Xₜ. For example, the electronic device may obtain Xₜ₋₁ by removing the estimated noise from Xₜ.

According to an embodiment, when t is not 1 (operation 870—No), the electronic device may modify t to a value of t−1 in operation 880.

According to an embodiment, the electronic device may proceed to operation 820, set t to a value smaller than the previous t value by 1, and perform operations 830, 835, 850, 855, 860, 856, and 870 again. According to an embodiment, the electronic device may repeatedly perform operations 830, 850, 860, and 870 while decreasing the value of t by 1 each time.

According to an embodiment, when t is 1 (operation 870—Yes), the electronic device may output the obtained Xₜ₋₁, which is X₀, as an estimated original audio data.

As such, the operation of training by combining an artificial intelligence model that uses audio data of a standard audio device as input data and an artificial intelligence model that sets a null value for the audio data of the standard audio device as input data may enable a more accurate prediction of non-linear distortion components of audio data of a target audio device.

According to an embodiment, when the null value for the audio data of the standard audio device is not used as training data, operations 835, 855, and 856 may be omitted.

According to an embodiment, an electronic device may include at least one processing including processing circuitry and memory storing instructions that, when executed by the at least one processor, individually or collectively, cause the electronic device to perform operations.

According to an embodiment, the instructions may be configured to, when executed by the at least one processor, individually or collectively, to cause the electronic device to input first audio data recorded through a first audio device and Gaussian noise as input data of an artificial intelligence model stored in the memory.

According to an embodiment, the instructions may be configured to, when executed by the at least one processor, individually or collectively, to cause the electronic device to, based on the first audio data and output data of the artificial intelligence model, obtain second audio data in which the first audio data is converted to include a feature of audio recorded in a second audio device.

According to an embodiment, the artificial intelligence model may be trained to, based on a diffusion model, generate diffusion data including noise in audio data based on audio data recorded in the second audio device and Gaussian noise, and extract the noise included in the diffusion data through an inverse process of the diffusion model.

According to an embodiment, the artificial intelligence model may be configured to generate the diffusion data by combining the audio data and the Gaussian noise at a set ratio.

According to an embodiment, the artificial intelligence model may be configured to perform training by repeating, a set number of times, operations of changing the set ratio, generating second diffusion data based on the changed ratio, and extracting second noise based on the second diffusion data.

According to an embodiment, the instructions may be configured to, when executed by the at least one processor, individually or collectively, to cause the electronic device to obtain the second audio data by removing noise, which is the output data of the artificial intelligence model, from the first audio data.

According to an embodiment, the instructions may be configured to, when executed by the at least one processor, individually or collectively, to cause the electronic device to obtain the second audio data by repeating, a set number of times, an operation of removing noise, which is the output data of the artificial intelligence model, from the first audio data.

According to an embodiment, the artificial intelligence model may be further configured to use audio data recorded in the first audio device as the input data.

According to an embodiment, the artificial intelligence model may include a first artificial intelligence model trained by further using audio data recorded in the first audio device as the input data, and a second artificial intelligence model trained without using audio data recorded in the first audio device as input data.

According to an embodiment, the instructions may be configured to, when executed by the at least one processor, individually or collectively, to cause the electronic device to obtain the output data by combining first output data of the first artificial intelligence model and second output data of the second artificial intelligence model.

According to an embodiment, the instructions may be configured to, when executed by the at least one processor, individually or collectively, to cause the electronic device to obtain the first output data through the first artificial intelligence model with a probability of 50% and obtain the second output data through the second artificial intelligence model with a probability of 50%.

According to an embodiment, the second audio data may be used as training data for an artificial intelligence model for at least one of sound, voice recognition, or speaker recognition of the second audio device.

According to an embodiment, a method for controlling an electronic device may include inputting first audio data recorded through a first audio device and Gaussian noise as input data of an artificial intelligence model stored in memory.

According to an embodiment, the method for controlling the electronic device may include, based on the first audio data and output data of the artificial intelligence model, obtaining second audio data in which the first audio data is converted to include a feature of audio recorded in a second audio device.

According to an embodiment, the artificial intelligence model may be trained to, based on a diffusion model, generate diffusion data including noise in audio data based on audio data recorded in the second audio device and Gaussian noise, and extract the noise included in the diffusion data through an inverse process of the diffusion model.

According to an embodiment, the artificial intelligence model may be configured to generate the diffusion data by combining the audio data and the Gaussian noise at a set ratio.

According to an embodiment, the artificial intelligence model may be configured to perform training by repeating, a set number of times, operations of changing the set ratio, generating second diffusion data based on the changed ratio, and extracting second noise based on the second diffusion data.

According to an embodiment, obtaining the second audio data may include removing noise, which is the output data of the artificial intelligence model, from the first audio data.

According to an embodiment, obtaining the second audio data may include repeating, a set number of times, an operation of removing noise, which is the output data of the artificial intelligence model, from the first audio data.

According to an embodiment, the artificial intelligence model may be further configured to use audio data recorded in the first audio device as the input data.

According to an embodiment, the artificial intelligence model may include a first artificial intelligence model trained by further using audio data recorded in the first audio device as the input data, and a second artificial intelligence model trained without using audio data recorded in the first audio device as input data.

According to an embodiment, obtaining the second audio data may include obtaining the output data by combining first output data of the first artificial intelligence model and second output data of the second artificial intelligence model.

According to an embodiment, obtaining the second audio data may include obtaining the first output data through the first artificial intelligence model with a probability of 50% and obtaining the second output data through the second artificial intelligence model with a probability of 50%.

According to an embodiment, in a non-transitory computer-readable recording medium storing instructions configured to be executed by at least one processor of an electronic device to input first audio data recorded through a first audio device and Gaussian noise as input data of an artificial intelligence model stored in memory of the electronic device.

According to an embodiment, the instructions when executed by the at least one processor, individually or collectively, can cause the electronic device to, based on the first audio data and output data of the artificial intelligence model, obtain second audio data in which the first audio data is converted to include a feature of audio recorded in a second audio device.

According to an embodiment, the artificial intelligence model may be trained to, based on a diffusion model, generate diffusion data including noise in audio data based on audio data recorded in the second audio device and Gaussian noise, and extract the noise included in the diffusion data through an inverse process of the diffusion model.

According to an embodiment, the artificial intelligence model may be configured to generate the diffusion data by combining the audio data and the Gaussian noise at a set ratio.

According to an embodiment, the artificial intelligence model may be configured to perform training by repeating, a set number of times, operations of changing the set ratio, generating second diffusion data based on the changed ratio, and extracting second noise based on the second diffusion data.

According to an embodiment, the instructions when executed by the at least one processor, individually or collectively, can cause the electronic device to obtain the second audio data by removing noise, which is the output data of the artificial intelligence model, from the first audio data.

According to an embodiment, the instructions when executed by the at least one processor, individually or collectively, can cause the electronic device to obtain the second audio data by repeating, a set number of times, an operation of removing noise, which is the output data of the artificial intelligence model, from the first audio data.

According to an embodiment, the artificial intelligence model may be further configured to use audio data recorded in the first audio device as the input data.

According to an embodiment, the artificial intelligence model may include a first artificial intelligence model trained by further using audio data recorded in the first audio device as the input data, and a second artificial intelligence model trained without using audio data recorded in the first audio device as input data.

According to an embodiment, the instructions when executed by the at least one processor, individually or collectively, can cause the electronic device to obtain the output data by combining first output data of the first artificial intelligence model and second output data of the second artificial intelligence model.

According to an embodiment, the instructions when executed by the at least one processor, individually or collectively, can cause the electronic device to obtain the first output data through the first artificial intelligence model with a probability of 50% and obtain the second output data through the second artificial intelligence model with a probability of 50%.

According to an embodiment, the second audio data may be used as training data for an artificial intelligence model for at least one of sound, voice recognition, or speaker recognition of the second audio device.

The electronic device according to embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
at least one processor including processing circuitry; and
memory storing instructions that, when executed by the at least one processor, individually or collectively, cause the electronic device to:
input first audio data recorded through a first audio device and Gaussian noise as input data of an artificial intelligence model stored in the memory; and
based on the first audio data and output data of the artificial intelligence model, obtain second audio data in which the first audio data is converted to include a feature of audio recorded in a second audio device, and
wherein the artificial intelligence model is trained to, based on a diffusion model, generate diffusion data including noise in audio data based on audio data recorded in the second audio device and Gaussian noise, and extract the noise included in the diffusion data through an inverse process of the diffusion model.

2. The electronic device of claim 1, wherein the artificial intelligence model is configured to generate the diffusion data by combining the audio data and the Gaussian noise at a set ratio.

3. The electronic device of claim 2, wherein the artificial intelligence model is configured to perform training by repeating, a set number of times, operations of changing the set ratio, generating second diffusion data based on the changed ratio, and extracting second noise based on the second diffusion data.

4. The electronic device of claim 1, wherein the instructions are configured to, when executed by the at least one processor, individually or collectively, cause the electronic device to obtain the second audio data by removing noise, which is the output data of the artificial intelligence model, from the first audio data.

5. The electronic device of claim 4, wherein the instructions are configured to, when executed by the at least one processor, individually or collectively, cause the electronic device to obtain the second audio data by repeating, a set number of times, an operation of removing noise, which is the output data of the artificial intelligence model, from the first audio data.

6. The electronic device of claim 1, wherein the artificial intelligence model is further configured to use audio data recorded in the first audio device as the input data.

7. The electronic device of claim 6, wherein the artificial intelligence model includes a first artificial intelligence model trained by further using audio data recorded in the first audio device as the input data, and a second artificial intelligence model trained without using audio data recorded in the first audio device as input data.

8. The electronic device of claim 7, wherein the instructions are configured to, when executed by the at least one processor, individually or collectively, cause the electronic device to obtain the output data by combining first output data of the first artificial intelligence model and second output data of the second artificial intelligence model.

9. The electronic device of claim 8, wherein the instructions are configured to, when executed by the at least one processor, individually or collectively, cause the electronic device to obtain the first output data through the first artificial intelligence model with a probability of 50% and obtain the second output data through the second artificial intelligence model with a probability of 50%.

10. The electronic device of claim 1, wherein the second audio data is used as training data for an artificial intelligence model for at least one of sound, voice recognition, or speaker recognition of the second audio device.

11. A method for controlling an electronic device, comprising:
inputting first audio data recorded through a first audio device and Gaussian noise as input data of an artificial intelligence model stored in memory; and
based on the first audio data and output data of the artificial intelligence model, obtaining second audio data in which the first audio data is converted to include a feature of audio recorded in a second audio device,
wherein the artificial intelligence model is trained to, based on a diffusion model, generate diffusion data including noise in audio data based on audio data recorded in the second audio device and Gaussian noise, and extract the noise included in the diffusion data through an inverse process of the diffusion model.

12. The method of claim 11, wherein the artificial intelligence model is configured to generate the diffusion data by combining the audio data and the Gaussian noise at a set ratio.

13. The method of claim 12, wherein the artificial intelligence model is configured to perform training by repeating, a set number of times, operations of changing the set ratio, generating second diffusion data based on the changed ratio, and extracting second noise based on the second diffusion data.

14. The method of claim 11, wherein obtaining the second audio data includes removing noise, which is the output data of the artificial intelligence model, from the first audio data.

15. The method of claim 14, wherein obtaining the second audio data includes repeating, a set number of times, an operation of removing noise, which is the output data of the artificial intelligence model, from the first audio data.

16. A computer program product comprising a non-transitory computer-readable recording medium storing instructions configured to be executed by at least one processor of an electronic device to perform a plurality of operations comprising:
inputting first audio data recorded through a first audio device and Gaussian noise as input data of an artificial intelligence model stored in memory; and
based on the first audio data and output data of the artificial intelligence model, obtaining second audio data in which the first audio data is converted to include a feature of audio recorded in a second audio device,
wherein the artificial intelligence model is trained to, based on a diffusion model, generate diffusion data including noise in audio data based on audio data recorded in the second audio device and Gaussian noise, and extract the noise included in the diffusion data through an inverse process of the diffusion model.

17. The computer program product of claim 16, wherein the artificial intelligence model is configured to generate the diffusion data by combining the audio data and the Gaussian noise at a set ratio.

18. The computer program product of claim 16, wherein the artificial intelligence model is configured to perform training by repeating, a set number of times, operations of changing the set ratio, generating second diffusion data based on the changed ratio, and extracting second noise based on the second diffusion data.

19. The computer program product of claim 16, wherein obtaining the second audio data comprises:
removing noise, which is the output data of the artificial intelligence model, from the first audio data; and
repeating the removing noise for a set number of times.

20. The computer program product of claim 16, wherein the artificial intelligence model is further configured to use audio data recorded in the first audio device as the input data, and wherein the artificial intelligence model includes a first artificial intelligence model trained by further using audio data recorded in the first audio device as the input data, and a second artificial intelligence model trained without using audio data recorded in the first audio device as input data.
